(19) United States
(12) Patent Application Publication
(10) Pub. No.: US 2013/0072706 A1
(43) Pub. Date: Mar. 21, 2013

(54) Recovery of Oleaginous Tricyglycerols from Wastewater Title of Invention Treatment Plant Foams

(71) Applicants: Elizabeth J. Summer, College Station, TX (US); Mei Liu, College Station, TX (US); Sarah Dugleby, College Station, TX (US)

(72) Inventors: Elizabeth J. Summer, College Station, TX (US); Mei Liu, College Station, TX (US); Sarah Dugleby, College Station, TX (US)

(73) Assignee: PHASE BIOCONTROL RESEARCH, LLC, College Station, TX (US)

(21) Appl. No.: 13/423,010

(22) Filed: Mar. 16, 2012

Related U.S. Application Data
(60) Provisional application No. 61/536,407, filed on Sep. 19, 2011.

(51) Int. Cl. C11B 13/00

(52) U.S. Cl. 554/167; 554/177; 554/1

(57) ABSTRACT

Tricyglycerols that may be converted to biofuel are recovered from oleaginous organisms in the natural and induced foam of wastewater treatment process plants. Growing oleaginous organisms in the form of comparatively dry foam simplifies harvest and is more efficient and efficacious than skimming the biomass off the top of the liquids that rely on less efficient centrifugation or filtration methods typically required to concentrate cells grown in liquids.

### RELATIONSHIP TO OTHER APPLICATIONS

This application claims benefit of U.S. Provisional patent application Ser. No. 61/536407, filed Sep. 19, 2011.

### BACKGROUND

1. Field of Invention

This invention is a process for production of biodiesel from wastewater treatment facilities. More specifically, the process comprises harvesting nocardioform bacteria-containing foam (naturally occurring or induced) from wastewater treatment facilities and recovering triacylglycerols (TAG) for further processing, as into biofuel.

2. Background Information

Foaming and the related problem of bulking are widespread phenomena in wastewater treatment facilities and are currently viewed as problems that must be controlled. The thick layers of brown foam are microbiological in origin. The foam that forms at typical municipal water treatment facilities, in warmer areas of the United States, are commonly composed of a large biomass of filamentous nocardioform bacteria, including Nocardia, Gordonia, and Rhodococcus. These organisms are also part of the normal flora of a healthy wastewater treatment system, as some bacterial filaments are required for proper floc formation and settling of solids. Foaming and bulking can occur when conditions promote the proliferation of these nocardioform organisms, resulting in the accumulation of very large bacterial biomass.

Nocardioforms are members of one of the few bacterial groups that are known to produce storage triacylglycerols (TAG). TAG is readily convertible into biodiesel-grade oil using established chemistries. One Nocardioform, Rhodococcus opacus, produces up to 78% dry mass TAG. The obvious advantages of harvesting foam for biodiesel-grade lipid extraction are the use of raw, untreated wastewater plant facilities. Many wastewater treatment plants already experience chronic foaming so production costs would be limited to harvesting the foam at established treatment plant facilities. Because of low production costs, effectively piggybacking on existing water treatment facilities, TAG yields on a dry basis do not have to be as high as are required for algal-or corn-based biofuels to be profitable. This invention has the potential to revolutionize both wastewater treatment and biofuel production by converting what has been considered a widespread problem into a renewable energy source. The environmental and societal benefits significance are potentially staggering.

There is a government mandate to develop practical alternative fuels in order to reduce dependence on nonrenewable petroleum products. The key is to develop these alternative fuels in an environmentally sound way, preferably by use of waste materials and use of methods that are neither energy-intensive, and which do not produce undesirable byproducts. Municipal wastewater represents a huge and untapped source of unused nutrients that can support the growth of biofuel producing organisms. Biofuels, typically formulated with alcohols or oils produced by plants, animals, fungi, or bacteria, are particularly attractive alternative fuels because they are derived from renewable resources yet can be used to run more traditional engines.

Ideally, however, biofuels should also be produced from waste materials and wastewater instead of high-value food crops and cultivatable lands. Intense research and preliminary commercialization efforts have been conducted towards the goal of converting waste materials into fuels. Most of this has focused on two systems: the use of plant biomass cellulosic materials as the feedstock for ethanol fermentation and developing large-scale algal production systems to extract algal oils for biodiesel.

Algal-based biofuels, including oils, alcohols, and even bio-gasoline, have been particularly attractive because algae have very high growth rates, which initially led to optimistic estimations of yields per acre of land (9,10). The actualization of algal biofuel production has faced daunting feasibility limitations. These limitations include cost and complexity of production facilities, issues in concentrating the algal cells and removing water, as well as difficulties extracting the biofuel in a profitable manner. An additional concern is the high water use needed for algal production. One estimate is that if algal biofuels replaced 48% of the current fossil fuels used for transportation purposes, the water use would be greater than three times what is currently required for field crop irrigation (11). The water-use issue could be offset if algae were grown in waters unusable for other purposes, such as high salinity or brackish waters, a particularly attractive option currently being evaluated by several high profile companies. Some feasibility studies indicate that biofuel producing algae cannot be profitably grown directly in unprocessed municipal wastewater. Similarly, oleaginous bacteria have been found not capable of high-yield growth on wastewater, also due to competing bacteria (12). An additional limitation of biofuel generating algal strains is that they tend to not compete well against other microorganisms.

Harvesting wastewater treatment plant foam for biodiesel production is highly innovative and addresses the specific problems that have confounded microbial biodiesel production. Most efforts to grow oleaginous algae and bacteria for biodiesel production are focused on developing these in large-scale, pure cultures using methods that are inhibited by invasive competing microbes. A significant drawback to these systems has been the energy intensive requirements for concentrating the cells away from the production liquids. The oleaginous organisms (either algal or bacterial such as Rhodococcus opacus) do not grow well in untreated wastewater because they are not adapted to out-compete the native organisms and/or wastewater is not an ideal nutrient source for them. Harvesting and concentrating the cells away from growth liquids and removal of excess water is expensive and energy intensive. These reasons explain why algal biodiesel in not a commercial reality. The oil producing algal strains have to be cultured in nearly pure conditions (so, no wastewater, only very fancy but expensive photoreactors), they are readily outcompeted by non-oil producing algal strains, and a lot of water has to be removed in order to harvest the cells. The same is true for Rhodococus opacus, it is already known that it does not grow in untreated wastewater.

In contrast, foaming nocardioforms are: 1. already optimized for growing and for competing with other microorganisms in untreated wastewater; 2. have foam and scum that is easy to harvest and concentrate; and 3. have foam and scum that is are drier than regular planktonic cells, requiring far less water removal.

The present invention provides a system that favors the growth of potentially oleaginous organisms in raw wastewater, in mixed cultures, and in a form that simplifies separating the cell biomass from the production waters.

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

This invention is a method harvesting from and promoting proliferation of oleaginous bacteria directly from wastewater by recovering hydrophopic nocardioform containing foam. Growing oleaginous organisms in the form of comparatively dry foam simplifies harvest and is more efficient and efficacious than skimming the biomass off the top of the liquids, that rely on less efficient centrifugation or filtration methods typically required to concentrate cells grown in liquids. The water content of the hydrophobic foam is also significantly less than the sludge, so in addition to being heavily enriched in nocardioform filaments, it is an easier to handle source of oleaginous biomass.

In one aspect the invention wastewater treatment plants will be retrofitted into configurations to promote foaming.

Key improvements of this invention include: 1. Growth on real wastewater (algae do not compete against existing microbes in wastewater and so it has to be sterilized, which is labor and energy intensive); 2. Easy to harvest foam (concentrating the cells is one of the largest hurdles for algal culture); and 3. Less water to remove since foam is naturally dryer then planktonic algal cell, so.

Some additional advantages include that facts that bacteria in foam: 1. Is already capable of growing on existing, unprocessed wastewater; 2. already exhibits a tendency to proliferate to extremely high biomass; 3. does not require pure, near pure, or closed culture conditions; 4. contains high enough levels of storage TAG to make extraction profitable; 5. does not require expensive or complex new production facilities to be established; 6. can use the self separating nature of foam simplifies cell harvest and concentration; 7. can be harvested without disrupting the system; 8. Allows bulk waters to remain in the system; and 9. does not adversely affect effluent water characteristics.

### DESCRIPTION OF FIGURES

The accompanying drawing, which are incorporated into and constitute a part of the specification, illustrate specific embodiments of the invention and, together with the general description of the invention given above, and the detailed description of the specific embodiments, serve to explain the principles of the invention.

FIG. 1 is a schematic diagram of a process embodiment of the invention illustrating foam recovery and processing to biodiesel.

### DETAILED DESCRIPTION

This invention, in broad aspect, is a process for recovering biofuel grade microbial oils from normal foaming in wastewater treatment plants by harvesting and extracting oleaginous (oil producing) bacteria that are cultured in the form of a thick microbial foam. The process comprises harvesting nocardioform bacteria-containing foam from wastewater treatment plants, recovering triacylglycerols (TAG) there-from and, optionally, processing the recovered TAG to biofuel—particularly bio-diesel. This system takes advantage of the tendency for filamentous nocardioform bacteria to grow directly in aeration basin waters where, despite competition from other organisms, they are still able to collect as thick hydrophobic bulk foam that floats on the surface of the aeration basin waters. This bulk foam format facilitates harvesting and concentrating the cells, as well as reducing the amount 1 of excess water that must be removed prior to oil extraction. This provides a means of economical cell harvesting, which has been a major limitation in other systems. The invention, in one embodiment, also comprises operating wastewater treatment plants to intentionally produce foam containing nocardioform bacteria for recovery of TAG.

Filamentous, foam-causing nocardioforms responsible for most foaming at municipal wastewater treatment plants include Nocardia, Gordonia, Dietzia and Rhodooccus. This invention capitalizes upon the connection between the oil producing property of common foam-causing bacteria and the fact that the foam is an easier to harvest cell format than other microbial and algal biodiesel production systems. While there have been other disclosures of methods to extract lipids from wastewater plants and turn them into biodiesel, they do not target the TAG in bacterial cells, but only the lipids that come in with the wastewater. See, for example U.S. Pat. No. 7,638,314, issued Dec. 29, 2009.

Foaming (and bulking) is a natural phenomenon that a majority of municipal and industrial wastewater treatment plants already experience. Foaming and bulking can occur as either chronic or acute microbial outbreaks, in the form of layers of thick brown foam up to a meter thick. The foam layers are composed of gas bubbles trapped and stabilized by a large mass of long, branched, hydrophobic filaments of nocardioform bacteria, including Nocardia, Gordonia, and Rhodococcus. Bacteria closely related to foam-producing nocardioform bacteria include, for example, Rhodococcus opacus PD630, which accumulates up to 78% dry mass TAG (triacylglycerols) as storage lipids (Table 1). TAG lipids are the same lipid components in vegetable oils that are used for other process for biodiesel production. Formation of TAG lipid storage bodies occurs widely only in the group of bacteria that includes the nocardioforms (the Actinomycetes). As a soil bacterium, R. opacus cannot be successfully cultivated in raw, unprocessed aeration basin liquids and there are currently no economical ways to produce R. opacus in the large volumes needed for biofuel production. While the level of TAG in the various wastewater foams will vary, the nocardioform bacteria contained in the foam are both capable of high volume foam formation and high storage TAG accumulation in raw aeration basin waters.

When the limited number of bacteria capable of forming storage bodies of TAG is taken into consideration, the potential correlation between foaming, during which nocardioform bacterial accumulate to a high biomass, and TAG production is even more fortuitous. Most bacteria do accumulate some sort of lipophilic compound in the form of an intracellular lipid-body. However, most accumulate either PHB (3-hydroxybutyrate) or PHAs (polyhydroxyalkanoates). TAG accumulation in storage bodies, while common among plants, is very uncommon among bacteria. The only group of bacteria capable of accumulating large quantities of TAG is in fact in the nocardioforms, including Nocardia, Rhodococcus, Gordonia, and Dietzia (Table 1). Isolates of all of these have been identified as abundant constituents of nocardioform foaming outbreaks in municipal wastewater treatment plants. TAG lipid body storage content of nocardioform growing as foam on municipal wastewater has not heretofore been considered as a source of biofuel grade oil.

Biodiesel-grade lipids can be extracted from sludge and regular (e.g. non-foaming) aeration basin liquids and solids. Lipid yields of almost 5% dry weight have been obtained from activated sludge, with a production cost of $3.11 per gallon, which was higher than the $ 2.50 per gallon price of soy diesel at the time of publications. It was noted that increasing yields to 10% would be required to bridge the cost gap between sludge diesel and soy diesel. The volumes dealt with at municipal wastewater facilities are not trivial. The 21,604 public municipal wastewater treatment facilities in the US produce over six million dry metric tons of sludge every year. Foam will provide higher yield, easier to extract source of biodiesel grade lipids than sludge.

TABLE 1
TAG Content of Nocardioform Bacteria

| | TAG (or cellular | | |
|---|---|---|---|
| | fatty acid) | | |
| Nocardioform | content (% by | Growth | Refer- |
| Species | cell weight, w/w) | Media | ence |
| Dietz maris | 19% | hexadecane | 1 |
| Gordonia app. DC | 30-96% | various | 2 |
| | | (molasses etc) | |
| Gordonia amarae | 6% | Gluconate, yeast | 1, 2 |
| | | extract, glucose | |
| Nocardia corallina | 24% | valerate | 3 |
| Rhodococcus opacus | 38-87% | various | 4-7 |
| PD5 630 | | (molasses etc) | |
| Rhodococcus rubber | 26% | hexadecane | 3 |

Conditions that promote nocardioform “blooms” and lead to foaming include aeration methods and influx water components. High levels of fats, oils and grease (FOG), promote the growth of nocardioforms and wastewater treatment plants that service food manufacturers are particularly prone to foaming. Proliferation of filamentous nocardioform is also promoted by conditions such as a low F/M (food to mass) ratio, when a plant runs with an extremely long sludge age, and when plants are run at higher temperatures. Foaming is also aggravated by plant design, as plants lacking primary scum removal, or plants that recycle scum, are particularly prone to foaming.

These known causes of foaming provide guidance for selection of suitable wastewater plants for TAG harvesting and to means for intentionally inducing forming for biofuel production. Manipulation of these conditions is used intentionally to cause treatment plants to produce foam for recovery and production of bio-diesel (or other bio-fuels).

In one embodiment the invention will comprise selecting treatment plants that are prone to foaming and that produce relatively high TAG containing nocardioform bacteria. Therefore, identification of high TAG bacteria is an important component of the process of the invention. To determine the suitability of any given wastewater treatment plant for foam recovery analysis of the foam is made to determine the concentration of TAG producing bacteria and the variability over a period of time. The kinds of bacteria present the foam will be largely determined by the nature of the feed water content. Plants with relatively constant feed content will be more suitable for the process of the invention. Plants given to excessive foaming, if the foam contains sufficient TAG producing bacteria, will be especially suitable as such and for conversion to intentional foaming design. Such analysis can be performed by methods known in the art and can, no doubt, be improved upon for the specific purposes of this invention based on experience with various operating plants.

Since foaming, and the related problem of bulking, is currently viewed by the wastewater treatment industry as a problem, deliberate running of a plant in “foaming mode” requires detailed analysis on the implications for total plant functioning. The primary purpose of a wastewater treatment facility is to process water into a form suitable for release into the natural water system. In one embodiment of the invention other aspects of plant function are be modified achieve this balance.

Conventional treatment plants can be operated in a “foam” mode by providing conditions known to cause excess foaming. Methods to promote foaming would initially be designed based on reverse engineering, using conditions known to help control foaming. There is a great deal of information on ways to reduce or control foaming. Operation conditions that reduce nocardioform foaming include increasing the wasting rate in order to reduce MCRT (mean cell residence time—a measure of sludge age). Removal of scum in return activated sludge control and increasing the F/M (food to mass ratio) are also known to reduce nocardioform foaming.

Additionally, it has been observed that high levels of fats and oils also promote nocardioform growth. Taken together, these known foaming conditions teach that increasing retention time, processing cooking oils and fats, but maintaining an overall low F/M ratio would generate a condition in which nocardioform foaming is promoted. In addition to operation mode, changes to the aeration basin format might also promote foaming. It is generally accepted that having “foam traps”, or areas of reduced circulation, will re-seed the basin with foam-generating bacteria. Also, using a return activated sludge system in which waters from the top of the basin are recycled, promotes retention and re-seeding of nocardioform.

In one embodiment, separate basins or lagoons are constructed alongside the aeration basin (the normal location of foaming) of existing treatment plants where foaming will be intentionally promoted by providing conditions that promote foaming as described above. These basins or lagoons will, optionally, be enclosed to prevent escape of and facilitate collection of the foam. Water, with foam removed can be recycled from the foaming basins into the treatment plant aeration basin or other suitable location in the process train. By “trapping” the foam and not letting it escape the basin, it will help to continuously “reseed” the waters and promote foaming. Conditions to promote growth of foaming bacteria, as discussed above include high grease and oil input, longer sludge age, low organic loading rates, and septicity or low oxygen conditions needed for these filaments to overgrow the system. Foam disposal into aerobic or anaerobic digesters will also result in foaming.

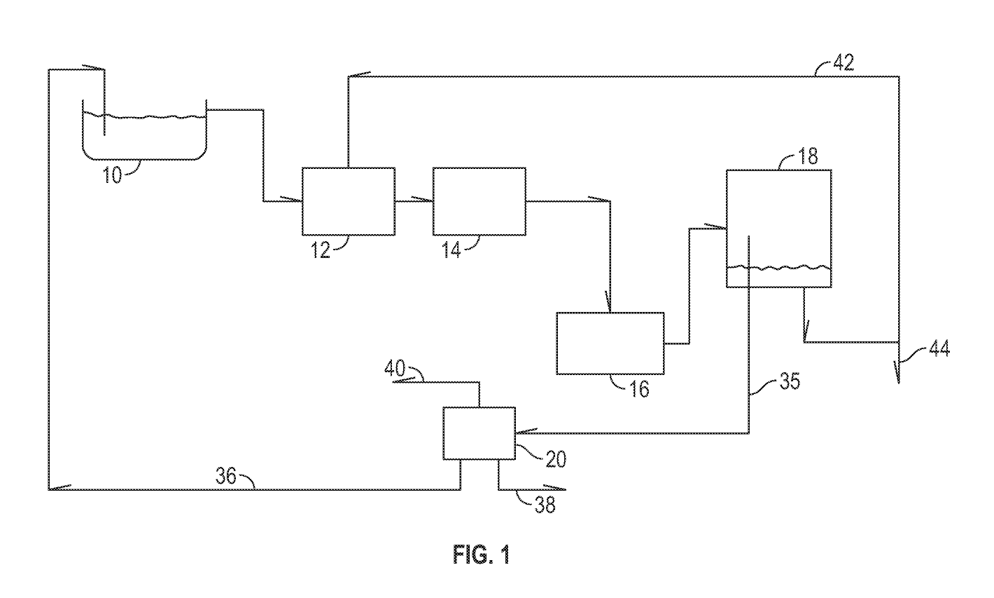

An embodiment of the integrated process on the invention is illustrated in FIG. 1. Foam containing TAG lipids is removed from vessel 10 (a foaming basin of a wastewater treatment plant) to stage 12 where the foam is broken to produce a process feed stream. Conduit 42 shows an optional recycle of glycerol produced in the process for use as a defoaming agent. From stage 12 the process stream passes to stage 14 for processing to break the bacteria cell wall and release TAG lipids for further process in stage 16, where the lipid stream is dewatered and otherwise prepared for the bio-diesel process. A novel means of breaking lipid foams with a sonicating device is described in US 2010/0261918, Pub. Oct. 14, 2010, the appropriate teaching of which is incorporated herein by reference. Glycol compounds are also effective defoaming agents. When prepared for tranesterification processing the feed stream passes to the tranesterification process stage, 18.

A product of tranesterification when using KOH (or other strong base) catalyst, is glycerol. A recycle, 42, stream of this produced glycerol can be used as a foam breaker in stage 12. Product biodiesel from stage 18 passes by conduit 35 to a washing stage 20. Optionally the biodiesel can be washed in stage 20 with effluent water, 40, from the treatment plant. Wash water, 36, passes back to a forward stage of the treatment plant. Washed, finished biodiesel is recovered through conduit 38. Glycerol is recovered through conduit 44.

The generic process scheme shown in FIG. 1 is only one variation of the process of the invention showing the possibility of recycle water and recycle glycerol as a foam breaker. All elements of the process to convert lipids, except the foam collection and foam breaking stage, are known in the art—much current research on similar processes for algae processing is being conducted world-wide and improvement in every stage of the process are being made. It is contemplated that optimum developments adapted for the particular lipids of this invention will be utilized in converting wastewater foam lipids to biodiesel.

A detailed description of the various processes for wastewater sludge treatment, wastewater plant operations and the processes for processing lipids and other oils to biodiesel is contained in U.S. Pat. No. 7,638,314, Dec. 29, 2009, the relevant teachings of which are incorporated herein by reference. In the foregoing specification, the invention has been described with reference to specific embodiments thereof. It will, however, be evident that various modifications and changes can be made thereto without departing from the broader spirit and scope of the invention as set forth in the appended claims. The specification is, accordingly, to be regarded in an illustrative rather than a restrictive sense. Therefore, the scope of the invention should be limited only by the appended claims.

### REFERENCES

1. Alvarez, H. M., and Steinbuchel, A. (2002) Appl Microbiol Biotechnol 60, 367-376

2. Gouda, M. K., Omar, S. H., and Aouad, L. M. (2008) World J Microbiol Biotechnolo 24, 1703-1711

3. Alvarez, H. M., Kalsheuer, R., and Steinbuchel, A. (1997) Fett/Lipid 99, 239-246

4. Alvarez, H. M., Mayer, F., Fabritius, D., and Steinbuchel, A. (1996) Arch Microbiol 165, 377-386

5. Waltermann, M., Luftmann, H., Baumeister, D., Kalscheuer, R., and Steinbuchel, A. (2000) Microbiology 146 (Pt 5), 1143-1149

6. Voss, I., and Steinbuchel, A. (2001) Appl Microbiol Biotechnol 55, 547-555

7. Kurosawa, K., Boccazzi, P., de Almeida, N. M., and Sinskey, A. J. (2010) J Biotechnol 147, 212-218

1. A process for recovering oleaginous tricyglycerols comprising harvesting nocardioform-containing foam from wastewater treatment plant water and recovering tricyglycerols there-from.

2. The process of claim 1 wherein the foam is harvested from existing wastewater treatment plants during times heavy foaming.

3. The process of claim 1 wherein the plant is intentionally operated to produce foam for harvesting.

4. The process of claim 1 wherein the oleaginous tricyglycerols are recovered from a group of bacteria selected from the group consisting of Nocardia, Rhodococcus, Gordonia, and Dietzia in the foam.

5. The process of claim 1 wherein the recovered tricyglycerols are processed to a form suitable to produce biodiesel.

6. The process of claim 5 wherein the tricyglycerols are converted to biodiesel by reaction with an alcohol by transterification.

7. The process of claim 3 wherein there is provided foaming basins separate from the process basins of a customary wastewater treatment plant from which oleaginous tricyglycerols are recovered.

8. The process of claim 1 wherein foaming basin is enclosed to facilitate harvesting of the oleaginous triacyglycerols.

9. A process of producing biodiesel comprising recovering oleaginous tricyglycerols from wastewater treatment plant foam, defoaming the foam, drying and reacting the dried tricyglycerols with alcohol and an suitable catalyst.

10. The process of claim 9 wherein the oleaginous tricyglycerols are recob vered from bacteria selected from the group consisting of Nocardia, Rhodococcus, Gordonia, and Dietzia in the foam

11. The process of claim 9 wherein a portion of glycerol produced in the reaction of tricyglycerols and alcohol is used as a defoaming agent in the process.

12. The process of claim 9 wherein the wastewater plant is intentionally operated to produce foam by providing conditions that produce foaming.

13. The process of claim 9 wherein there is provided foaming basins separate from the process basins of a customary wastewater treatment plant from which oleaginous tricyglycerols are recovered.

14. The process of claim 8 wherein the foaming basin is enclosed to facilitate harvesting of the oleaginous triacyglycerol.

15. A composition comprising oleaginous tricyglycerols recovered from wastewater treatment plant foam.

16. The composition of claim 15 wherein the oleaginous tricyglycerols are recovered from bacteria selected from the group consisting of Nocardia, Rhodococcus, Gordonia, and Dietzia in the foam.
